(19) United States
(12) Patent Application Publication
(10) Pub. No.: US 2002/0049644 A1
(43) Pub. Date: Apr. 25, 2002

(54) Method for simplified one-touch ordering of goods and services from a wired or wireless phone or terminal

(76) Inventor: James B. Kargman, Chicago, IL (US)

Correspondence Address: LAW OFFICES OF DICK & HARRIS, Suite 3800, 181 W. Madison Street, Chicago, IL, 60602, US

(21) Appl. No.: 09/966,223

(22) Filed: Sep. 28, 2001

Related U.S. Application Data
(60) Provisional application No. 60/236,267, filed on Sep. 28, 2000.

(51) Int. Cl. G06F 17/60

(52) U.S. Cl. 705/26

(57) ABSTRACT

A system for the convenient and automated execution of a commercial transaction from a wired or wireless customer device, such as a cellular telephone, is provided. A transaction code is transmitted by the customer device to initiate the transaction. The customer device can be automatically populated with preconfigured codes for the initiation of various transactions. Advertising and other promotional materials can also be conveyed to the customer device.

### BACKGROUND OF THE INVENTION

1. Field of the Invention

This invention relates in general to the conducting of electronic commerce, such as the purchasing and advertising of goods and/or services, using a wired or wireless terminal or device. In particular, the invention relates to a system for convenient rapid entry of repeat orders for goods or services via cellular phone, as well as the targeted delivery of advertising or promotional information to mobile individuals.

2. Background Art

In recent years, the volume of commerce transacted on the Internet has grown dramatically. Internet users enjoy the convenience of learning about products, comparison shopping, and placing orders for goods and services at any time of the day or night, from a personal computer all without leaving their home or office.

Due in good part to its speed, breadth and efficiency, Internet shopping has pervaded nearly every aspect of commerce. Consumers and businesses alike now conduct a vast array of commercial transactions electronically, including such things as requesting restaurant delivery service, booking travel reservations, and purchasing products such as groceries, electronics, books, household supplies, office supplies, furniture, kitchen equipment, and prescription drugs.

As more users incorporate electronic commerce activities into their daily lives and as more type of goods and services become available for purchase, it becomes highly desirable to maximize the convenience of conducting commercial activities via

means other than by being physically present at a retail store establishment or by otherwise interacting with a human operator by telephone as in the case of conducting a mail order transaction.

As users increasingly turn to the Internet for their daily needs, many users find themselves repeatedly engaging in common transactions over the Internet. Prior art systems of placing orders via the Internet require the user to use a PC, access the Internet and enter all the details of such a desired order each time the order is placed. Some users may be dissatisfied, or even deterred from placing an order online, due to the ensuing inconvenience and effort of specifying and placing the order. By minimizing the effort required by a user to place an electronic order with a vendor, the likelihood of that user placing the order with the vendor is maximized. Therefore, it is an object of this invention to allow users to place repeat orders automatically, with minimal effort on the part of the user.

The frequency with which an individual uses a service tends to increase with the simplicity and convenience of using the service. This is particularly the case for consumable goods that may be ordered by a consumer on a periodic and ongoing basis. To date, various prior art devices have provided, or in the case of U.S. Pat. No. 5,960,411 have attempted to provide true “one-touch” ordering of goods or services. However, such prior art devices have typically comprised PC-based devices which communicate over the Internet to the computer systems of businesses or vendors offering goods and services. Additionally, the prior art system disclosed in the '411 patent requires that the user go through the effort of (1) first launching an Internet web browser software application, (2) logging into and entering the vendor's web site, (3) navigating the vendor's web site to locate the desired items or services to be ordered, and (4) tagging each the items desired, which are only then processed as an order.

Thus, there exists the opportunity for conducting even greater levels of commerce and affording consumers even greater convenience by permitting true one-touch ordering of goods and services, particularly without the need to access and use a PC. Therefore, it is highly desirable to provide a system for improving the speed and efficiency of conducting commercial transactions via a wireless device. It is also desirable to implement a one-touch order without the need to use a PC or access the Internet. Another desirable aspect of the invention provides automated configuration of electronic commerce transactions, thereby maximizing the convenience to the user.

Finally, the present invention empowers users to take advantage of electronic commerce in various mobile settings. However, many aspects of existing electronic commerce systems are configured for use by users with access terminals residing in fixed locations. Therefore, it is also desirable to provide for targeted dissemination of information or routing of commercial transactions based upon both current geographic location and anticipated future geographic location, thereby facilitating electronic commerce for such mobile users.

### SUMMARY OF THE INVENTION

The invention provides convenient, rapid and targeted mechanisms for conduction of electronic commerce, particularly in conjunction with mobile electronic devices. A technique for executing a commercial transaction is implemented via the electronic transmission of a transaction code from a customer to a business with whom the transaction is to occur. The transaction code is transmitted by a wired or wireless electronic device operated by the customer, such as a cordless telephone. The transaction code is received by an order processing system, such as a computer server. The system then identifies the customer and authenticates the transmission to deter fraud or mischief. Finally, the system determines a commercial transaction that is associated with the transaction code, and automatically executes the commercial transaction. This procedures provides for true one-touch execution of a commercial transaction.

The transaction code can be of a variety of formats. For example, if the ordering process is implemented in conjunction with a cellular telephone, the transaction code may be a dial sequence which is sent to a public switched telephone network via a wireless cellular communications link. Transaction codes can also be implemented by web-enabled cellular telephones or other web-based devices in the form of a Universal Resource Locator (“URL”) which can be transmitted onto the Internet or another data network. Regardless of the nature of the transaction code, it may be stored in memory provided by the customer's electronic device.

The contents of the transaction codes are variable, and may depend upon the particular system implemented. For example, some transaction codes may include full information describing the desired transaction embedded within the code. Other codes may include a reference to a preconfigured order stored within a vendor database. In system for which security is a concern, authentication mechanisms may be provided, such as password entry or message encryption.

In accordance with another aspect of the invention, caller identification features provided by many public telephone networks can be utilized to identify the customer. Where a transaction code is conveyed via placement of a call on a public telephone network, the vendor order processing system may detect the caller identification information conveyed from the telephone network to lookup information relating to the user and/or the desired commercial transaction from a vendor database.

In accordance with another aspect of the invention, customer devices can be automatically populated with transaction codes, thereby further increasing the convenience to the customer. A transaction code containing encoded information for the automatic execution of a commercial transaction is generated by a vendor. The transaction code is then electronically conveyed to the customer's device, such as via text messaging or infrared communications. The transaction code can then be automatically stored within the customer's device, thereby avoiding the potentially cumbersome process of manually entering a transaction code. The transaction code can thereafter be transmitting by the customer's device to initiate the execution of an associated commercial transaction with minimal effort on the part of the customer.

In addition to transmitting transaction codes to a customer's device, the aforementioned process may also be utilized to transmit other advertising or promotional information to user devices, with or without a transaction code. Furthermore, in the context of mobile customer devices such as cellular telephones, the transmission of transaction codes or other promotional information can be targeted for dissemination within a desired geographical area. Location detection technologies, such as cellular triangulation or GPS reporting, can be utilized to track the current and projected future location of a customer device. Customers can then be targeted for receipt of transaction codes and/or promotional information relating to businesses operating within the region where the customer is currently located, or within a region through which the customer is expected to travel. The promotional information itself may also utilize the customer's location information. For example, a map may be transmitted to the customer indicating the customer's current location and the location of a vendor. Furthermore, customers may implement filters to accept only desired messages, such as messages from a particular vendor or from vendors within a particular region.

### BRIEF DESCRIPTION OF THE DRAWINGS

FIG. 1 is a schematic diagram of a communications system providing for electronic commerce applications in a mobile environment.

FIG. 2 is a flowchart of a first embodiment of a one-touch order process.

FIGS. 3a, 3b and 3c are diagrams of one-touch order codes.

FIG. 4 is a flowchart of a second embodiment of a one-touch order process that incorporates encryption techniques.

FIG. 5 is a flowchart of a third embodiment of a one-touch order process utilizing caller identification technology.

FIG. 6 is a flowchart of a process for configuring one-touch ordering.

FIG. 7 is a flowchart of a process for targeted dissemination of communications to mobile users for facilitating one-touch ordering and electronic commerce.

FIG. 8 is a flowchart of a process for targeted dissemination of communications to mobile users based upon a user's anticipated future location.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

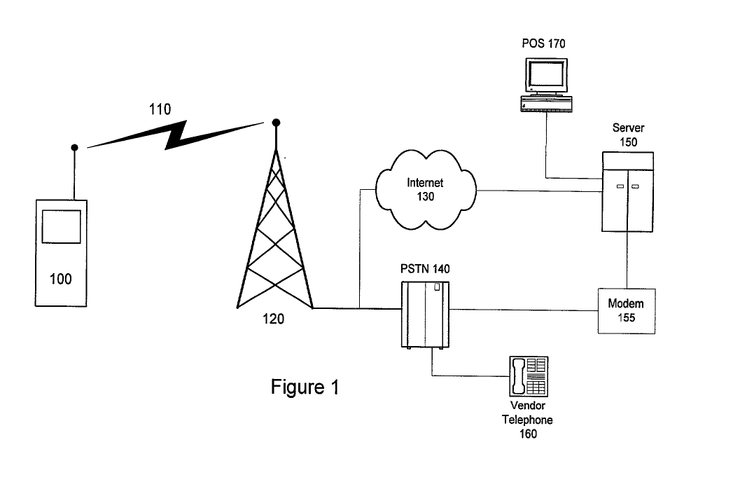

The present invention provides for the facilitation of electronic commerce via the automatic placement and execution of commercial transactions and the targeted dissemination of information to mobile consumers. Many of the apparatuses and methods taught herein can operate in conjunction with a variety of user terminals, including a conventional telephone, either wired or wireless. One example of a system capable of implementing several embodiments of the invention disclosed herein utilizes a cellular telephone as the user terminal, and is depicted in FIG. 1. Thus, for purposes of this disclosure, reference will be made to use of a wireless device comprising a cellular telephone. Other devices, both wired and wireless, are contemplated as being within the scope of various embodiments of this invention, including conventional wired telephone sets.

Cellular telephone 100 communicates with cellular service provider infrastructure 120 via wireless communications link 110. Cellular infrastructure 120 is connected via at least one communications network to electronic commerce server 150. The specific nature of the communications network depends upon the communications process being implemented. For example, if cellular telephone 100 is a web-enabled device transmitting URL information, it may be desirable to conduct communications over a packet-based data network such as the Internet 130. In an embodiment in which cellular telephone 100 transmits orders via keypad or speed-dial DTMF signals, communications may occur over public switched telephone network (“PSTN”) 140, and server 150 may be equipped with an analog telephone line modem 155 for connection to the PSTN.

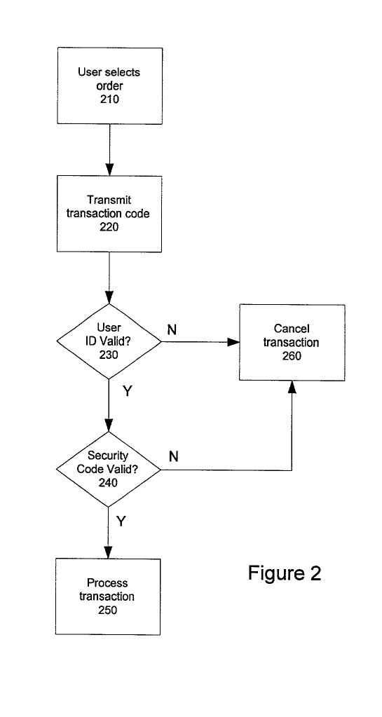

FIG. 2 illustrates an embodiment of the invention capable of rapidly and conveniently placing electronic orders via a communications system such as that of FIG. 1. In step 210, the user selects a predetermined transaction code which represents the commercial transaction intended by the user. For example, a transaction code corresponding to the delivery of a large pepperoni pizza from a local pizza restaurant to a user's home could be stored within cellular telephone 100. One way in which the transaction code may be stored is as a sequence of dialing digits in the speed dial memory of cellular telephone 100. If cellular telephone 100 is web-enabled, the transaction code could alternatively be stored as an Internet URL containing encoded information.

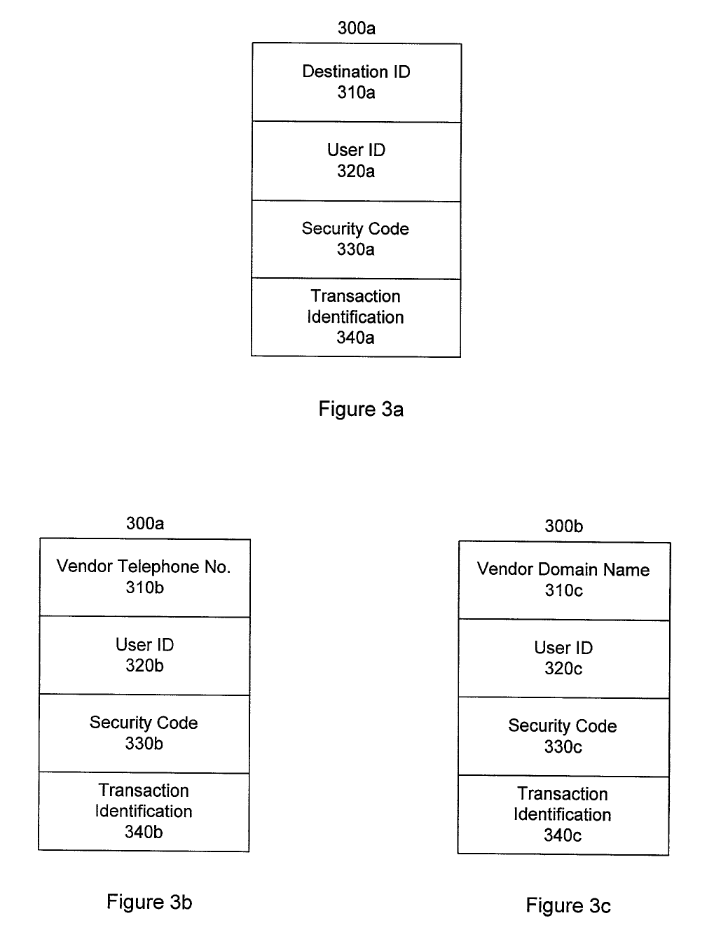

One embodiment of a transaction code is illustrated in the diagram of FIG. 3a. The transaction code 300a is comprised of a plurality of data fields. Destination ID 310a specifies the intended routing of the transaction code through a communications network to vendor system 150. User ID 320a is uniquely associated with the customer, such as a customer login name, which identifies the customer sending the order to vendor system 150. Security code 330a is a confidential field used by vendor system 150 to authenticate the sender of a transaction code, such as a login password. Finally, transaction identification field 340a conveys the nature of the transaction that is requested.

The specific content of transaction code 300a depends upon the technique that will be used to store and transmit the transaction codes. For example, transaction code 300b (FIG. 3b) is stored in cellular telephone 100 as a sequence of dialing digits in the “speed dial” memory. The destination ID 310b is comprised of a telephone number associated with a vendor's automated order receiving system, such as the telephone number of modem 155. Fields 320b, 330b and 340b are comprised of a sequence of DTMF digits encoding the customer ID, security code and order information, respectively.

When cellular telephone 100 is web-enabled, or when other web-based communications devices are utilized, the transaction code may be stored as an Internet URL, e.g., order code 300c (FIG. 3c). In such an embodiment, the destination ID 310c may be comprised of the domain name or Internet address of a vendor's electronic commerce server 150, such as “http://onetouch.quikorder.com/”. Fields 320c, 330c and 340c are ASCII characters comprising further URL fields appended to destination ID 310c which can be decoded by server 150 to specify the User ID, security code and transaction identification, respectively.

In step 220, the transaction code is conveyed to the intended product vendor or service provider. For example, where transaction code 310b is selected, the cellular telephone dials the stored sequence of DTMF digits. The first transmitted data element comprises the telephone number of the business order processing system. In the embodiment of FIG. 1, the business order processing system is a computer based telephony system comprised of modem 155 and server 150. Using pauses and other characters such as the “#” or “*”, the various elements of transaction code 310b are transmitted to server 150. Specifically, the dial sequence is conveyed by cellular infrastructure 120 to PSTN 140. PSTN 140 routes the telephone call to modem 155 according to the telephone number encoded in destination ID 310b. Modem 155 then receives the call, along with the remaining dialed digits stored in fields 320b, 330b and 340b. These dialed digits are decoded by the modem, and their contents are passed on to vendor server 150.

Alternatively, if transaction code 310c is selected, the Internet access portion of cellular telephone 100 transmits the URL query of transaction code 310c to cellular infrastructure 120 via a data call. The URL query is sent to Internet 130, where it is routed to server 150 according to the Internet address of destination ID 310c. Server 150 receives the URL and decodes the contents of fields 320c, 330c and 340c.

While transaction codes have been illustrated in the context of speed dial digits and an Internet URL, it is also contemplated that a transaction code could be conveyed from a user terminal to server 150 via other means of data transmission as well. For example, the transaction code could be stored as a predetermined instant message, and transmitted over the Internet using instant messaging systems. The order code could also be stored as a predetermined text sequence and transmitted using two-way paging or text messaging techniques.

In step 230, server 150 determines whether the user ID 320a received within the transaction code is a valid user ID, such as by referencing the received user ID with a user database stored within the server. If not, the order is aborted, step 260. If the user ID is valid, server 150 proceed to compare the security code received in order code field 330a to the known security code stored within a business database and associated with the received user ID, step 240. If the security code does not match, the order is aborted, step 260. If the security code is valid, then the order is processed, step 250.

The method in which the order is processed in step 250 may depend upon the configuration of the order code. For example, in one embodiment of the invention, transaction identification field 340 may be comprised of a reference number associated with a predetermined commercial transaction, such as the delivery of a large pepperoni pizza to the user's home address. In this case, server 150 may reference a database to associate the reference number of field 340 with details of the transaction, such as the type of pizza desired, the selection of delivery service, the address to which the order is to be delivered, the method of payment, and any other information appropriate for a particular embodiment of the invention. Payment for the order can be made through prearranged means such as a credit card charge, an auto-debit arrangement, through prearranged debiting or charging to the user's telephone number account or through charging to an account maintained by a web commerce provider. The use of a reference to a previously-configured entry in an order database allows for implementation of arbitrarily complex transactions while allowing for an order code of limited, fixed and predetermined length.

In another embodiment, transaction identification field 340 may contain parameters specifying the transaction details, such that pre-configured transaction information need not be stored by the vendor. Such parameters may include data specifying the exact goods and/or services desired. Accordingly, the vendor need only identify the customer information associated with the customer identification parameters before executing the transaction.

In yet another embodiment of the invention, the transaction identification field could be null, i.e. omitted entirely. Such a transaction code could be utilized in a system in which a single predetermined action is desired, such as the automatic repetition of the last order placed by the user, which may be stored in a database such as a Point of Sale (“POS”) system.

Server 150 may optionally be linked directly to a POS system, e.g. POS system 170, such that order information can be directly and automatically entered therein. For example, in the case of a pizza delivery restaurant, server 150 can enter an order into POS system 170, such that a customer check and kitchen order are automatically generated. Server 150 could also be linked simply to a printer on the premises of a business, whereby the customer's order can simply be printed out and then acted upon by order fillers employed by the vendor.

As an example, a customer using cellular telephone 100 wishing to order his/her standing order for a large pepperoni pizza and six pack of soda from the local pizza parlor, can do so by simply pressing a “speed dial” key on cell phone 100 which would transmit predetermined order code 310b, specifying the desired order information, to the restaurant hosting server 150. The order is then received by the business system, verified and an order is generated pursuant to the restaurant's order mechanism. In this manner, the user forgoes the need to speak to a human operator or otherwise interact with a computerized order entry system to place a repeat order.

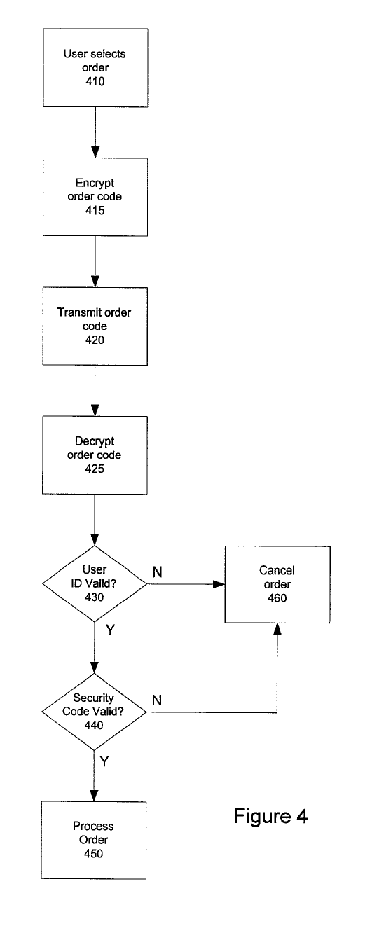

Various security measures are contemplated to insure that no fraud or abuse occurs. For example, the transmission of the order code can be encrypted using a public-private key system, and/or an embedded security code could be used as described above. An embodiment of the invention utilizing encryption is illustrated in FIG. 4. Steps 410, 420, 430, 440, 450 and 460 are analogous to steps 210, 220, 230, 240, 250 and 260, respectively. However, before transmitting the transaction code, the portion of the transaction code other than the destination ID is encrypted in step 415 using one of the many data encryption systems known in the art. Upon receiving the transaction code, server 150 decrypts the code fields in step 425 according to the predetermined encryption system, before processing the transaction code contents.

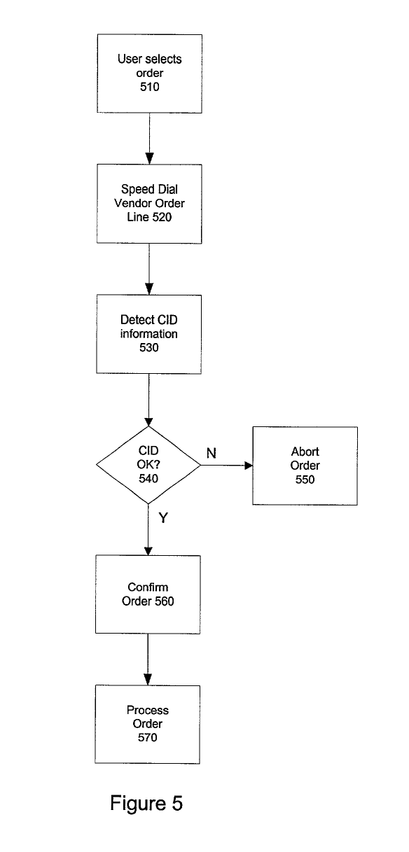

In another embodiment of the present invention, the automatic ordering system may utilize caller identification (CID) information automatically provided by most public telephone systems. Such an embodiment is illustrated in FIG. 5. In operation, the user selects a speed dial telephone number sequence associated with a vendor's automated order line to initiate a telephone call from cellular telephone 100, step 510. The call is routed through PSTN 140 to the computer-based automated ordering system comprised of modem 155 and server 150, step 520. Meanwhile, as the call is routed to modem 155, PSTN 140 automatically transmits CID information associated with the telephone line from which the call has originated, i.e., cellular telephone 100. Modem 155 and server 150 capture the CID information, step 530, and check the CID information against a computer customer database to determine, for example, if the customer has called before and has activated one touch ordering for her/her account, step 540. If the CID information is not recognized, is associated with a customer who has not enabled one-touch ordering, or is otherwise invalid, the automatic ordering process is aborted, step 550. If the CID information is recognized, confirmation step 560 can optionally be provided. For example, in step 560 a voice prompt to the user in synthesized human speech can be generated by server 150 and communicated back to the user via modem 155 and PSTN 140. The user may be presented with options such as for pressing “1” to repeat the last order, pressing “2” to hear specials, or pressing “3” to speak to a live operator to place a new order. Alternatively, the vendor system may accept user commands via voice recognition technology to trigger placement of a standing order. If the customer confirms that a predetermined order, such as a repeat of the customer's previous order, is desired, then the order is automatically processed in step 570 according to order information associated with the CID information that was received in step 530.

If voice recognition is used, a more sophisticated order entry system can be configured. In accordance with one aspect of such a system, the security of the system can be further enhanced. For example, upon the calling the vendor system, the system may play the caller a greeting asking for the user to enter an access code. The user may utter the phrase “go 1234” which causes the system to accept the access code 1234 and verify its authenticity by comparing the code to a predetermined value associated with the user's CID information in a server 150 user database. A reserve word menu can also be implemented where, for example, the caller utters the phrase “attention repeat dinner”. The system would respond by playing to the caller a list of prior orders associated with the user's detected CID information as stored in a server 150 order database. Also, new menu items could be selected and purchased using additional voice commands.

While the one-touch ordering process described herein is advantageous for improving the convenience and efficiency of performing commercial transactions, the order codes described above must be initially configured. In accordance with another aspect of the invention, remote and automatic programming of a wired or wireless terminal or device can be provided. For example, cellular telephone 100 can be populated with speed dial telephone numbers corresponding to one-touch transactions, or the address book of a web-enabled telephone can be populated with URL transaction codes, toward facilitating the configuration of a “one touch” ordering system.

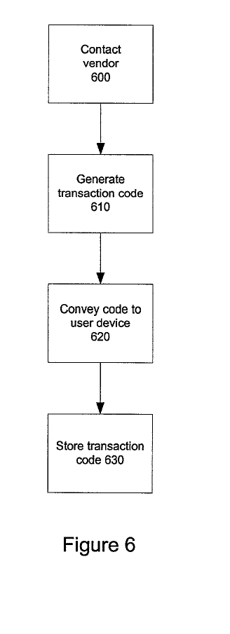

FIG. 6 illustrates one technique for configuring one-touch transactions on a user terminal. The technique of FIG. 6 is designed to operate using a cell phone or other device that has the ability to detect incoming messaging and to execute a software program or operation in response to an appropriate incoming message. Instead of requiring the user to manually program his/her phone with the text order string or URL, the vendor system transmits the appropriate text order string or URL to the phone which, in turn, receives, detects and automatically programs its phone book or memory with the received order text string or URL.

In step 600, contact is initiated between the user and a vendor, such as may be required to manually place an order via a conventional ordering mechanism. For example, in the context of FIG. 1, cellular telephone 100 may call telephone 160 residing on the premises of a vendor or service provider, such as a pizza restaurant, towards orally placing an order. Alternatively, if cellular telephone 100 is web-enabled or if the user is at a computer terminal with access to Internet 130, the user may access such a restaurant's Internet web site, hosted by server 150, to place such an order. While contacting the vendor, the user may be offered or may request a one-touch transaction code for use in conveniently placing future orders.

In step 610 the vendor generates a transaction code corresponding to the one-touch order configuration requested by the user. For example, a POS system operated by a telephone order-taker may automatically generate a transaction code corresponding to the order that has just been placed. If the vendor was contacted in step 600 via a web site interface, the vendor's web server may generate the transaction code.

The transaction code is conveyed to the user device in step 620, and stored within the user device in step 630. The customer can obtain and store the transaction code in any number of ways, where the complexity of the particular transaction code may be considered in determining which method is most appropriate. For example, in step 600 the user may initially place an order for a pizza by placing a telephone call with cellular telephone 100 to pizza parlor telephone 160 and speaking to a human operator. After taking the customer's order by phone, the customer may be offered the option of receiving a transaction code toward being able to execute a repeat order for the same pizza and other items at a later date. The business would then generate the order text string from its order processing computer system in step 610 and orally communicate the transaction code to the user in step 620. Where the transaction code is intended to populate a speed dial location within cellular telephone 100, such as transaction code 300b, the user can manually enter the dial sequence into the speed dial memory of cellular telephone 100 in step 630. Alternatively, the customer may place an order on-line via the Internet with web-enabled cellular telephone 100 or with any other device with Internet access, as opposed to speaking to a live operator, and a transaction code may be conveyed visually for entry and storage in the user's device in step 630, such as by “bookmarking” a transaction code URL. A vendor can convey the transaction code to the customer in other ways as well, such as by sending an email or sending a written mailing. A URL transaction code can be stored as an icon in a web-based communications device with a graphical user interface. Accordingly, a tray or window could be configured holding one or more one-touch URL icons, whereby a user could have the ability to immediately place a desired order, such as an order for a particular office supply, by simply clicking the associated icon.

The process of FIG. 6 can also be employed to implement an automated programming mechanism whereby transaction codes can be communicated to a user without requiring the manual entry of a possibly complex string of data. In step 600, the user additionally identifies the device that is intended to store the transaction code, to the vendor. For example, if cellular telephone 100 is to be automatically populated with a one-touch transaction code, the vendor is provided with the telephone number of cellular telephone 100. In the context of an Internet or web based device, the vendor is provided with the URL, instant messaging address or other electronic identifier corresponding to the target device. One convenient way in which the one-touch device can be identified is by capturing the necessary phone number or URL at a time when that customer places an order via a conventional ordering technique. For example, when a customer calls a pizza parlor and orders a large pepperoni pizza and six pack of soda, the customer might be asked to authorize the vendor system to automatically populate the customer's phone with a transaction code. The operator would then take down the appropriate information, including the one-touch device identifier (e.g. the telephone number or Internet address of cellular telephone 100), and enter it into the vendor's system. The customer could also provide the vendor system with its identifying information, such as a telephone number or Internet address and the desired order, by using an Internet connection to the vendor's web site.

In response, the vendor system would electronically send a message to the customer's device that includes the transaction code in step 620. For example, vendor server 150 may electronically transmit a text message to cellular telephone 100 via Internet 130, cellular infrastructure 120 and wireless communications link 110. The text message includes a transaction code, such as dial sequence 300b or URL 300c. It is contemplated that within the customer device, a directory such as a phone book or Internet “favorites list” could be provided for with a range of entries that are designated for storage of transaction codes and use with one-touch transactions. The customer device could further be configured to provide for an auto save feature such that speed dial sequences or URLs received via text messaging in step 620 are automatically stored into the phone book or “favorites list” in step 630. Optionally, storage step 630 may query the user of the customer device for authorization to store the transaction code prior to doing so. The need to manually enter the order code can thereby be eliminated.

In another embodiment of the invention, cellular telephone 100 receives a communication from vendor server 150 in step 620 which contains an embedded transaction code and which further triggers the execution of an application such as a Java Applet. The application receives, decodes and/or otherwise recognizes the incoming message and, if appropriate security measures are met, automatically writes the text order string or URL to a memory location in the telephone memory in step 630. In this manner the vendor is able to remotely program a customer's phone, populating the phone book or other database in which transaction codes can be stored.

In addition to automatically populating a customer device database pursuant to a specific request from a customer, the present invention can also be employed to exploit location-based technologies that are now being designed into cellular telephones and other mobile communications devices to provide targeted and automatic dissemination of transaction codes or other information for the facilitation of electronic commerce by mobile consumers. A number of location based technologies are contemplated, including on-board GPS integrated directly into a mobile communications device, and cellular system triangulation, wherein a cellular infrastructure system itself determines the location of a mobile device within its cell network.

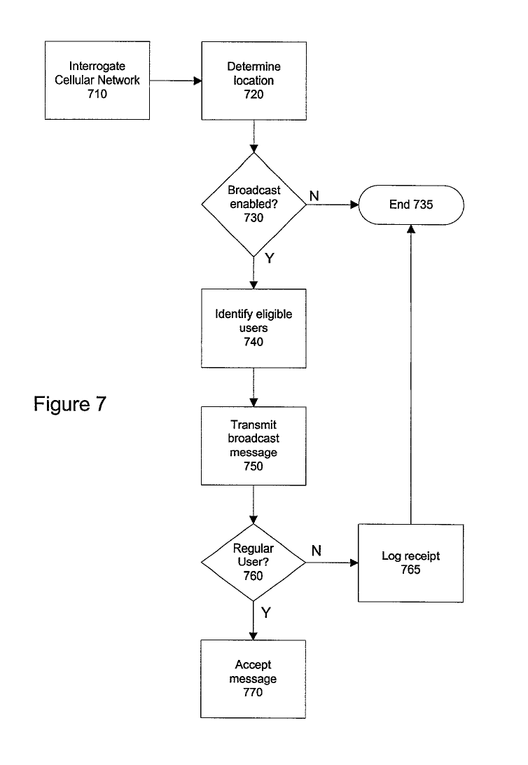

FIG. 7 illustrates an embodiment of this aspect of the invention implemented with the cellular system of FIG. 1. In step 710, vendor server 150 interrogates cell site 120 to determine the identity of cellular devices that are registered to the interrogated site, such as cellular telephone 100. The concept of cellular telephones is, of course, based upon the dispersion of communications service across a plurality of geographic regions, each region being services by a different cell site, such that no one site has to keep track of every cellular phone on-line and registered with the system. Instead, cell phones are only recognized by the site or sites to which the phone is within a predetermined physical proximity. Thus, in step 710, vendor system 150 polls or otherwise probes or interrogates cell site 120 to identify the telephone numbers or other device identifier corresponding to phones or devices that are near cell site 120.

In step 720, cell site 120 determines the geographic location of the cellular devices with which it communicates, such as cellular telephone 100. If the query from vendor system 150 merely requests all devices within the cell of site 120, then site 120 must merely identify each device as being within its cell. Alternatively, site 120 may more specifically determine the position of each handset within the cell using one of many location systems known in the art of radio and cellular communications. For example, the cell phones themselves may be equipped with a GPS system such that the phone itself can identify its precise geographic location and transmit that location to the cellular network. A phone's location could also potentially be derived via radio triangulation using signals received by a cell antenna within a particular cell (i.e. cell site 120) and within adjoining cells. The end result in both cases is that the cellular infrastructure can identify wireless devices within a particular region in step 720.

One or more mechanisms can optionally be provided whereby the user of a cellular telephone or other mobile communications device can selectively or indiscriminately disable the receipt of broadcast communications, thereby preventing inconvenience to the user that may result from receipt of unsolicited messages. Such a mechanism is provided by step 720, in which the election to receive broadcast messages is determined for each device identified in step 710. The determination may be based, for example, upon a query of each device by the cell site, or the election to receive or block broadcasts may be determined by querying a database maintained within the cellular system. If a device is configured to refuse broadcast communications, then the messaging process is aborted in step 735.

A device may be configured to reject all broadcast messages, to reject certain broadcast messages, or to allow only certain messages. For example, customers interested in the offerings of a particular commercial chain could set their wireless device to accept suggestive sales information from the closest store in the desired chain. Alternatively, the wireless device could be configured to accept all advertisements from merchants within a desired geographic radius. A user could also configure their wireless device to accept all advertisements and contact information from merchants in a given locale, zip code, town or other location identifier. Finally, a wireless device could be set to accept special offers from a specific class of merchants. Such offers could be sorted by type, value or location at the user's discretion. Such offers may include a transaction code for implementation via the user's wireless device.

If broadcast messaging for cellular telephone 100 is enabled, then a determination is made as to whether cellular telephone 100 is eligible for receipt of the particular message transmission in step 740. Step 740 allows a vendor system to identify the phone numbers or internet addresses of phones or other wireless devices within a specific desired geographic region, such as within a predetermined distance of the vendor's business location. If the desired geographic region is simply the cell in which cellsite 120 operates, then all devices registered to cell site 120 are identified as eligible devices. If the desired region is narrower, then a determination is made as to whether the location determined in step 720 lies within the desired region. The vendor can then target the transmission of its broadcast notices or advertisements or other promotional offers to enabled phones or devices within the desired region, step 750. Such phones or devices would then receive the broadcast information and present their users with the option to engage in further commerce by acting upon the notice, ad or offer.

For example, a gourmet coffee store could broadcast to motorists within a five mile range of the store that the store is running a special. The store system server knowing which phone numbers are within the area would make contact each such enabled device and transmit to those devices an indication that may be accepted by the phone to either generate advertising and or actually populate a speed dial memory location on the phone with a one-touch transaction code.

Optionally, additional criteria can be provided to further control the receipt of such broadcast messaging. For example, a cellular phone could be programmed to accept “broadcast” messages from businesses that are within the vicinity of the user's regular travel patterns, such as could be determined if a message from a given vendor is received more than a threshold number of times. Such a criterion is implemented at step 760. If cellular telephone 100 determines that the broadcast message received in step 750 that at least a predetermined number of messages from the same vendor have been received in the past, it is likely that the vendor's business targets a region regularly traveled by the cellphone user, and the message is accepted in step 770. Otherwise, cellular telephone 100 logs receipt of a message from the vendor, step 765, and completes the operation without displaying or activating the message contents. In this manner, the phone can detect that the user passes by a given vendor/business with enough frequency to warrant accepting its broadcasts.

The messages broadcast via the process of FIG. 7 can optionally be configured such that the received notices, ads, offers and/or transaction codes can be either automatically deleted from or automatically retained in the user's cellular telephone or other mobile device upon the satisfaction of a predetermined criterion. The criterion may be specified by a field within the message itself, or may be configured by the user of the cellular telephone. Such deletion criteria may include the expiration of a predetermined period of time, the first use of a transaction code (such as in the case of a one-time offer), the transport of the cellular telephone a specified distance from the vendor's physical location, or the passage of a given period of time over which the user failed to acknowledge or respond to the notice, ad or offer. For example, a gourmet coffee store may wish to transmit offers that are programmed to be automatically deleted by the recipient wired or wireless device after a set period of time be it hours, minutes or days after an initial order is made or further upon detection that the phone has traveled a predetermined distance from the business and as such the user would be unlikely to return back to that place to take advantage of the offer. It is further possible to configure the system such that categories or types of businesses, users and the like are maintained such that matches can be made that are more like to generate business to the stores subscribing to the system and are more likely to be used and beneficial to the users of the system thereby promoting its use.

The one-touch order and automatic broadcast message distribution technologies can also be implemented as the basis of a business model. One embodiment of such a model might implement the information dissemination process of FIG. 7. A business can exist which operates a server that identifies wireless or wired devices that are available or on-line within one or more geographic areas. The server may optionally have access to a database containing identity and/or demographic data that can be referenced with the identity of each device detected. The server could then match the identities of the on-line wired or wireless devices with vendors who have subscribed to the business operator's service in step 740. When such matches are made a triggering event occurs such that a broadcast is made to the matched device by the server, thus dispatching to that phone or wireless device an advertisement offer or other materials that the subscriber businesses seek to disperse. Additionally, rather than merely transmitting an automated message or programmed offer for a particular product in step 750, the bandwidth of the cellular system network could permit the transmission of streaming video or audio transmitted from the server to the wireless device. Furthermore, the geographic location information determined in step 720 could be utilized to dynamically generate a map keyed to the present location of the device, such that the device user who accept and views the map would be able to physically see directions from the user's present location to the location of the vendor that generated the offer.

As a wireless phone technology advances, location-finding technologies become increasingly available for tracking not only the current location of a wireless device, but also the change in the position of a wireless device over time. However, existing technologies for the placement and routing of certain types of orders via electronic commerce are based upon an assumption that the customer's location is fixed. The fixed location can then be compared to predefined service areas associated with vendors to identify one or more optimal vendors for servicing the customer. For example, such systems are sometimes used in placing an order for a pizza from a large pizza restaurant franchise via the Internet. An appropriate restaurant for the carry-out or delivery order is chosen by comparing the customer's reported location at the time of the order with service area maps for each restaurant. Thus, the selection of a vendor involves an assumption of a fixed location.

However, such systems are frequently not optimal for routing commercial transactions when the customer's location is moving and not fixed. For example, if a carry out order is placed for a pizza by a user driving a car, the store closest to the driver at the time the order is placed may be completely inappropriate inasmuch as the driver may be long gone by the time the pizza is ready 30 minutes later. Similarly, with respect to the dissemination of transaction codes or other promotional messaging, such as is illustrated by FIG. 7, it may be desirable to communicate with a potential customer a predetermined period of time before the customer actually arrives in the vicinity of the vendor.

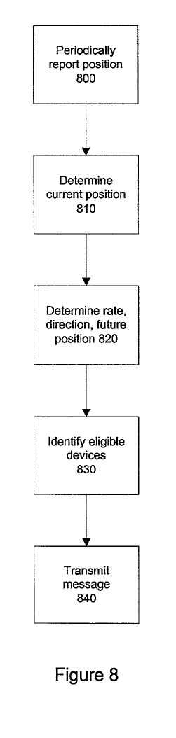

One example of how the present invention is able to adapt to and in fact take advantage of a changing geographic position that is updated as the wireless device moves is illustrated by the process of FIG. 8 implemented in conjunction with the system of FIG. 1. The geographic location of cellular telephone 100 is periodically identified via a location finding system, such as a GPS receiver on the cellular telephone, step 800, thus creating a series of positional samples over time. The customer's location is determined to be the most recent positional sample, step 810, and the anticipated position at a specific time in the future is determined by the estimated direction and rate of travel, which are calculated based upon the time difference relative to each positional sample, step 820. Accordingly, the system is able to determine not just where the wireless device is at one point in time, but also where it is likely to be at some time in the future.

One way that this location information can be utilized by server 150 is for the identification of wireless devices satisfying predetermined location criteria associated with a vendor, step 830. For example, a store may have a designated service area and may be precluded by a franchisor from trading outside that boundary. When a cell phone is dynamically determined to be either inside a store's service boundary, or on the way into such a boundary, a store location may provide advertisements or other promotional offerings, such as discount offers and the like, to the cell phone, step 840.

One way such promotional offerings may be provided in step 840 is through the transmission of a banner advertisement with a dynamic wireless location sensitivity attribute that allows an ad to be dynamically generated on a web page which would contain customer preference and location targeted messages for products and services marketed in the trade area in which the cell phone is currently located, or the area in which the cell phone is anticipated to arrive, as determined in step 820.

The identification of devices eligible to receive a promotional offering could also be based upon a calculated radius of accessibility for the device. The radius of accessibility estimates the geographical region over which the device user could reasonably travel to engage in a commercial transaction. This region can be determined for each user based upon the direction and speed of travel. For example, for stationary wireless devices, a radius could be constructed based upon a reasonable walking distance from the current location of the device. For moving wireless devices, the region may consist of a semi-circle in front of the direction of travel. The radius of the semi-circle may depend upon the speed of travel, inasmuch as the distance that could be covered with reasonable effort on the part of the customer increases with the average speed of the customer. Furthermore, the arc covered by the semi-circle may decrease as the travel speed of the device increases, thereby accounting for the increase in inconvenience likely to be caused by deviation from the current direction of travel as travel speed increases. Messages or transmissions from vendors with locations or target commercial areas within the radius are conveyed to the device. Thus, either the store's trade area, or the wireless device's positional, directional and speed information could create overlapping areas of opportunity for business information and trade.

The foregoing description and drawings merely explain and illustrate the invention and the invention is not limited thereto except insofar as the appended claims are so limited, inasmuch as those skilled in the art, having the present disclosure before them will be able to make modifications and variations therein without departing from the scope of the invention.

I claim:

1. A method of electronically executing a commercial transaction between a customer and a vendor, the method comprising the steps of:
transmitting electronically a transaction code from the customer to an electronic order processing system associated with the vendor;
receiving the transaction code by the order processing system associated with the vendor;
identifying the user based upon the contents of the transaction code;
authenticating the transaction code;
identifying a commercial transaction associated with the transaction code; and
executing the identified commercial transaction.

2. The method of claim 1, where the transaction code is comprised of a telephone dialing sequence, and the step of transmitting a transaction code is comprised of the step of applying the transaction code dial sequence to a line associated with a public switched telephone network.

3. The method of claim 1, in which the transaction code is comprised of a Universal Resource Locator, and the transaction code is transmitted via the Internet.

4. The method of claim 1, in which the step of transmitting a transaction code is comprised of the step of transmitting a transaction code that has been previously stored within digital memory associated with a wireless telephone via a wireless communications network.

5. The method of claim 1, in which the step of identifying the user is comprised of the substeps of:
identifying the contents of a user identification data field within the transaction code;
locating the user identification data field contents within a database accessible by the order processing system.

6. The method of claim 3, in which the step of authenticating the transaction code is comprised of the substeps of:
identifying the contents of a security code field within the transaction code;
determining that the received transaction code is authentic when the contents of the security code field correspond to a previously-configured security code associated with the contents of the user identification data field, which previously-configured security code is stored within a database accessible by the order processing system.

7. The method of claim 3, in which the step of authenticating the transaction code is comprised of the substeps of:
identifying a decryption key associated with the contents of the user identification data field;
decrypting at least a portion of the transaction code using the identified decryption key;
determining whether the decrypted portion of the transaction code is valid.

8. The method of claim 1, in which the step of authenticating the transaction code is comprised of the substeps of:
identifying a decryption key based upon the identity of the user;
decrypting at least a portion of the transaction code using the decryption key.

9. The method of claim 1, in which the step of identifying a commercial transaction associated with the transaction code is comprised of the substeps of:
determining the contents of a transaction identification field within the transaction code;
locating the contents of the transaction identification field within a database accessible by the order processing system;
identifying the nature of the commercial transaction based upon information within the database associated with the contents of the transaction identification field.

10. The method of claim 1, in which the step of identifying a commercial transaction associated with the transaction code is comprised of the substeps of:
determining the contents of a transaction identification field within the transaction code;
identifying the nature of the commercial transaction based upon information within the transaction identification field.

11. The method of claim 1, in which the step of identifying a commercial transaction associated with the transaction code is comprised of the substeps of:
locating a record within a database associated with the order processing system based upon the identity of the user;
retrieving details of the commercial transaction from the database record associated with the user.

12. The method of claim 3, in which the database is maintained within a point of sale computer system operated by the vendor.

13. The method of claim 1, in which the step of executing the identified commercial transaction is comprised of the step of entering the identified commercial transaction into a point of sale computer system operated by the vendor.

14. A method of electronically executing a commercial transaction between a customer and a vendor, the method comprising the steps of:
dialing a transaction code comprised of a telephone dial sequence onto a telephone network directed to an order processing system associated with the vendor;
receiving a telephone call by the order processing system as a result of the dialing of the transaction code;
detecting caller identification information received by the order processing system from the telephone network in conjunction with the telephone call;
detecting at least a portion of the transaction code dial sequence by the order processing system associated with the vendor;
identifying the user based upon the caller identification information received by the order processing system;
identifying a commercial transaction associated with the transaction code; and
executing the identified commercial transaction.

15. The method of claim 3, in which the step of identifying a commercial transaction is comprised of the substeps of:
identifying a record in a database associated with the order processing system based upon the received caller identification information;
retrieving details of the commercial transaction from the database record associated with the received caller identification information.

16. The method of claim 3, the method further comprising the step of authenticating the user before executing the identified commercial transaction.

17. The method of claim 3, in which step of authenticating the user is comprised of the substeps of:
prompting the user to enter a passcode;
determining that the passcode entered corresponds to a passcode value previously stored within a database record associated with the caller identification information.

18. A method for configuring an electronic user device for the automated execution of a commercial transaction between a customer and a vendor, the method comprising the steps of:
generating a transaction code comprised of encoded information associated with the commercial transaction;
conveying the transaction code to the user device electronically;
storing the transaction code within the user device;
transmitting the transaction code by the user device to initiate the execution of the commercial transaction with which the transaction code is associated.

19. The method of claim 3, in which the electronic device is a wireless telephone, and the transaction code is stored within telephone book memory of the wireless telephone.

20. The method of claim 3, in which the electronic device is a wireless telephone, the transaction code is comprised of a telephone dialing sequence, and the transaction code is stored within telephone book memory of the wireless telephone.

21. The method of claim 3, in which the transaction code is comprised of a Universal Resource Locator.

22. The method of claim 3, in which the transaction code is conveyed to the electronic device via wireless messaging.

23. The method of claim 3, in which the step of storing the transaction code is comprised of the substeps of:
identifying wireless message as a transaction code capable of storage within the user device;
programming the transaction code into digital memory within the user device without requiring substantial intervention by the user.

24. The method of claim 3, where the transaction code is generated by a point of sale system associated with the vendor in response to a request by the customer.

25. A method for the dissemination of information to a mobile electronic user device based upon the device location, for the facilitation of a commercial transaction between a customer and a vendor, the method comprising the steps of:
identifying the location of the user device;
determining that the location of the user device conforms to a predetermined location criterion for receipt of a message;
conveying the message to the user device electronically.

26. The method of claim 3, in which the message is a transaction code which can be stored within the user device and subsequently transmitted by the user device to initiate a commercial transaction.

27. The method of claim 3, in which the step of determining that the location of the user device conforms to a predetermined criterion for receipt of a message is comprised of the step of determining that the location of the user device lies within a predetermined geographical region associated with the vendor.

28. The method of claim 3, in which the user device is a cellular telephone, and the step of identifying the location of the user device is performed via triangulation techniques implemented by the communications infrastructure with which the cellular telephone operates.

29. The method of claim 3, in which the user device includes a global positioning system receiver, and the step of identifying the location of the user device is performed by receiving location information provided by the global positioning system receiver.

30. The method of claim 3, which method further comprises the step of determining that the message satisfies one or more filter criteria preconfigured by the customer.

31. The method of claim 3, in which the filter criteria are satisfied when one or more of the following message attributes conform to predetermined user preferences: the identity of the vendor; the geographical location of the vendor; the zip code in which the vendor is located; the city in which the vendor is located; the nature of the business conducted by the vendor; the frequency with which the customer enters the area in which the vendor does business; and the frequency with which the customer receives messages from the vendor.

32. The method of claim 3, which method further comprises the step of automatically deleting the transaction code from the user device upon the satisfaction of a deletion criterion.

33. The method of claim 3, in which the deletion criterion is the expiration of a predetermined period of time since the transaction code was stored within the user device.

34. The method of claim 3, in which the deletion criterion is the transmission of the transaction code by the user device.

35. The method of claim 3, in which the deletion criterion is the transportation of the user device a predetermined distance from a location associated with the vendor.

36. The method of claim 3, in which the message is comprised of map information identifying the location of the user device and a location associated with the vendor.

37. A method for the dissemination of information to a mobile electronic user device based upon the device location, for the facilitation of a commercial transaction between a customer and a vendor, the method comprising the steps of:
identifying the current location of the user device;
identifying the direction and rate at which the user device is moving;
determining that the location, direction of travel and rate of travel of the user device conform to one or more predetermined criterion for receipt of a message;
conveying the message to the user device electronically.

38. The method of claim 3, in which the step of determining that the location, direction of travel and rate of travel of the user device conform to one or more predetermined criterion for receipt of a message is comprised of the substeps of:
determining the anticipated location of the user device at a predetermined time in the future based upon the current location, rate of travel and direction of travel;
determining that the anticipated location of the user lies within a predetermined region associated with the vendor.

39. The method of claim 3, in which the step of determining that the location, direction of travel and rate of travel of the user device conform to one or more predetermined criterion for receipt of a message is comprised of the substeps of:
calculating a radius of accessibility for the customer operating the user device as an estimate of the geographical region over which the customer would travel to engage in a commercial transaction, which calculation is based upon the location, rate of travel and direction of travel of the user device;
determining that a location associated with the vendor lies within the radius of accessibility.
